(19) United States
(12) Patent Application Publication
(10) Pub. No.: US 2017/0165931 A1
(43) Pub. Date: Jun. 15, 2017

(54) METHOD FOR MANUFACTURING A LENS STRUCTURE

(71) Applicant: Anteryon Wafer Optics B.V., Eindhoven (NL)

(72) Inventors: Edwin Maria Wolterink, Valkenswaard (NL); Koen Gerard Demeyer, Genk (BE); Willem Matthijs Brouwer, Eindhoven (NL)

(21) Appl. No.: 15/327,321

(22) PCT Filed: Jun. 30, 2015
(86) PCT No.: PCT/NL2015/050477

§ 371 Date: Jan. 18, 2017

Related U.S. Application Data
(60) Provisional application No. 62/019,226, filed on Jun. 30, 2014.

(30) Foreign Application Priority Data
Jun. 30, 2014 (NL) 2013093

(51) Int. Cl. B29D 11/00; G02B 3/08; B33Y 80/00; B29C 65/48; B33Y 10/00; B29C 67/00

(52) U.S. Cl. CPC B29D 11/00403; B33Y 10/00; B29C 67/0051; B33Y 80/00; B29D 11/00355; B29C 65/48; G02B 3/08; B29L 2011/0016

(57) ABSTRACT

The present method relates to a method for printing a three-dimensional lens structure, comprising a step of depositing multiple fragments of printing material on a substrate and a step of curing the deposited fragments to build up said three-dimensional lens structure, wherein said substrate comprises a mould having a well defined surface area.

The present invention relates to a method for manufacturing a lens structure.

Several methods exist for manufacturing a lens structure. One well known method is the replication of UV curing and thermo setting polymers. According to the replication technology precise optical surfaces can be combined with thin layers (diaphragms, optical coatings, filters etc.). In addition, several lenses with different refractive index can be layered. A disadvantage of the replication technology is that shrinkage occurs during curing causing difficulties in controlling shape deformations and warpage, particularly at heights>500 micron and with combination with bulky mechanical features in the same material. Another method for manufacturing a lens structure is injection moulding. Injection moulding enables more freedom in combined optomechanical features, but moulds are expensive, throughput times are long and do not allow integration of heterogonous materials.

International application WO 2013/167528 relates to a method for printing three-dimensional structures in such a manner that the three-dimensional structure has initially a smooth surface after printing, comprising the steps of depositing multiple droplets of printing material at least partially side by side and one above the other and curing the deposited droplets by light irradiation to build up a three- dimensional pre-structure in a first step and smoothing at least one surface of the three-dimensional pre-structure by targeted placement of compensation droplets in boundary areas of adjacent deposited droplets and/or in edges of the surface to be smoothed in a second step to build up the three-dimensional structure with a smooth surface. This international application requires the locations of the compensation droplets to be calculated in dependency of the locations of the deposited droplets. The required number, positions and/or sizes of compensation droplets for smoothing the surface of the pre-structure can be calculated from the known positions of droplets forming the pre-structure derived directly from the printing data. The shape accuracy is largely determined by the capability of inkjet technology, wherein the size of the smallest droplet is nowadays above micron level, whereas many optical surfaces require submicron level shape accuracy.

French application FR 2996161, corresponding to International application WO 2014/049273, relates to a method for manufacturing an ophthalmic lens having at least one optical function, which comprises the step of additively manufacturing a complementary optical element by depositing a plurality of predetermined volume elements of a material having a predetermined refraction index on a predetermined manufacturing substrate. A lens is printed on a temporary substrate, and then the lens is removed from the substrate, wherein the lens thus removed is glued on a substrate having a specific optical surface. A solid lens is adhered to the optical surface in an additional step wherein the lens has to be deformed to match this surface. For many optical designs such a deformation is not possible or causes stresses in the assembly resulting in delamination and undesired optical effects, such as birefringence. According to this International application the lens shape has been created only after transferring the 3D printed preform to a mould.

US 2009/250828 relates to a method for manufacturing an ophthalmic device comprising: introducing a volume of photocurable material into a container; wherein said container comprises a mold surface; creating a digital 3-D mathematical model defining corrective needs of an eye; and projecting programmed patterns of UV light through said mold via a pattern generator; wherein said programmed patterns of UV light cure said photocurable material into an ophthalmic device shape defined by said mold surface and said digital model. This US patent application relates thus to a method for producing an ophthalmic device by means of stereolithography, wherein patterned actinic radiation is delivered to the device-forming material in order to form a layer of the ophthalmic device. Programmed patterns of ultraviolet (UV) radiation are projected through a male mold, which forms the lens' back surface, causing the device-forming material to cure into the desired shape of a lens.

WO 2007/045335 relates to a method for the production of optical lenses from a moldable transparent material, the method comprising either depositing the material on a substrate in a layer that is immediately cured or forming the lenses by depositing the material sequentially in several layers or zones. This method results in optical lenses wherein its lens function as such is present at the surface opposite to the substrate on which the material has been deposited. The substrate as such does not function as a mould for obtaining the lens functions. The substrate as such has a planar surface, wherein the lens bodies are generated by a material application method such as imprinting or spraying of the material onto the substrate, the lenses being generated by several serially applied material layers or partial regions.

US 2005/145964 relates to a sol-gel method of manufacturing an optical sensor, comprising a step of causing globular particles having different refractive indices to eject on the surface of the photo-detection element from an ink-jet apparatus having a nozzle provided with a temperature control part by controlling temperature of the nozzle, and forming a laminate of globular particle layers having different refractive indices. This US patent application relates to a sol-gel process wherein a sol-gel solution is filled into an ink jet apparatus which will ejects a globular particle of the sol-gel solution from its nozzle. The globular particle ejected from the ink jet apparatus is put on the flattened layer corresponding to the top surface of the thermopile type infrared detection element and piled up in three-dimensional manner. Between the globular particles thus deposited an air space or cavity is present. In this way, with patterning of the particle layer having low refractive index and the particle layer having high refractive index the three-dimensional photonic crystal lens can be manufactured in which a lensing effect is added to the cubic element of three-dimensional photonic crystal.

US 2013/122261 relates to a method of manufacturing a spacer wafer for a wafer-level camera, comprising a step of positioning a substrate in an additive manufacturing device; and forming the spacer wafer for the wafer-level camera over the substrate by an additive manufacturing process, wherein the additive manufacturing process comprises at least one of direct metal laser sintering (DMLS), selective laser sintering (SLS), fused deposition modeling (FDM), stereolithography (SLA), and three-dimensional (3D) printing. The spacer wafer is created directly on the substrate or glass wafer, one layer at a time, or a standalone spacer wafer is produced by forming the spacer wafer on a substrate formed of some sacrificial material layer, such as polypropylene or wax, and then removing the sacrificial material, leaving the standalone spacer wafer. This method requires at least one additional process or assembly step for integrating the lens shape with a spacer structure.

The 3D model includes data defining the object in three dimensions. The 3D model data are broken down into a vertical stack of multiple cross-sections, slices or layers. The three-dimensional (3D) printing system and/or process manufactures the object by creating the layers or slices one at a time, arranged in a vertical stack. When all of the slices or layers are complete, the object has been completely fabricated.

An object of the present invention is to provide method for manufacturing lens structures having a high surface and shape accuracy.

Another object of the present invention is to provide a method for manufacturing lens structures wherein lens structures comprising different types of materials, e.g. refractive index, Abbe number, can be obtained.

Another object of the present invention is to provide a method for manufacturing lens structures wherein lens structures having complex shapes, dimensions and sizes can be obtained.

Another object of the present invention is to provide a method for manufacturing lens structures for creating accurate annex structures around the optical surface of the lens structures.

The present method thus relates to a method for printing a three-dimensional lens structure, comprising a step of depositing multiple fragments of printing material on a substrate and a step of curing the deposited fragments to build up said three-dimensional lens structure, wherein said substrate comprises a mould having a well defined surface area for obtaining said three-dimensional lens structure.

The present inventors found that by using such a method for printing a three-dimensional lens structure one or more of the above identified objects can be achieved. The manufacturing time and the production costs for printed articles with suchlike three-dimensional structures can be reduced substantially compared to the prior art. The printing material may comprise transparent or translucent printing ink, such as an UV curable liquid monomer which becomes a polymer by curing. The fragments are printed onto the mould having a well defined surface area and the substrate does not form a part of the printed article. The term fragments as used herein include droplets, i.e. liquids, and powders, i.e. solids. The term “a mould having a well defined surface area” refers to the specific shape of the mould, i.e. the shape of the mould is such that the desired three-dimensional lens is formed therein and obtained therefrom. The preferred shape of the present lens structure is of the diffractive or refractive type, which shape can be described by optical formulas.

According to a preferred embodiment the present method further comprises forming an intermediate layer in said mould before said step of depositing multiple fragments of printing material on said mould. Such an intermediate layer of liquid UV curable or thermo setting polymer is applied to ensure a perfect match with the subsequent deposited fragments of the printing process.

According to the present invention the step of depositing multiple fragments of printing material is carried out such that no cavities or air spaces exist between the deposited multiple fragments of printing material. In addition, according to the present method the step of depositing multiple fragments of printing material takes place on a substrate, wherein the substrate comprises a mould having a well defined surface area, wherein the surface area provides the desired shape of the lens thus manufactured. This is in contrast with some of the above discussed prior art documents in which the surface on which the deposition takes place is a flattened or planar surface. Such a flattened or planar surface is not within the meaning of the present substrate, i.e. according to the present invention the substrate has a well defined surface area, namely a specific shape, wherein the shape of the mould is such that the desired three-dimensional lens shape is obtained.

The present method further requires a step of curing the deposited fragments to build up the three-dimensional lens structure, wherein the three-dimensional lens structure is created in the mould itself. Thus, according to the present invention the lens functions as such are located in the mould, and not in an area opposite to the mould. The step of curing requires that the inclusion of air bubbles in the deposited fragments should be prevented. The step of depositing multiple fragments of printing material is carried out such that no air bubbles are present in the deposited fragments.

The present method further comprises the removal of the mold from said three-dimensional lens structure after curing.

According to a preferred embodiment it is preferred to bond together two three-dimensional lens structures obtained according to the present method. According to such a method the contact surface between these two three-dimensional lens structures is formed by the surface remote from the mould having a well defined surface area. This means that the contact surface is not the lens shape surface but the area remote from the mould having a well defined surface area. In such a situation two flat surfaces are bonded together. When bonding together two of such three-dimensional lens structures it is preferred that the lens structures of these two three-dimensional lens structures differ from each other.

According to a preferred embodiment of the present method the deposition of the multiple fragments of printing material on the substrate is carried out such that the surface of the three-dimensional lens structure opposite to the mould, in which the three-dimensional lens structure is created, is flattened. Thus, the final lens structure has a side which can be identified as the lens shape and a side which can be identified as a flattened side. The embodiments in the present description will further explain this aspect. This flattened or planar surface provides also the possibility to combine two of such three-dimensional lens structures by bonding, e.g. glueing the flattened surfaces of both three-dimensional lens structures together.

The step of bonding comprises preferably the application of a bonding medium chosen from the group of adhesive and printing material used for printing said three-dimensional lens structures.

The contact surface between two of such three-dimensional lens structures can be functionalized by the provision of one or more functional layers, such as structured (e.g. holes) coatings, light blocking, filters, black matrix, PEDOT and LCD films, foils, diaphragm, aperture, additional glass substrates, flex prints, for example FR4. PEDOT films refer to poly(3,4-ethylenedioxythiophene), i.e. an electrically conducting polymer.

According to a preferred embodiment the step of depositing multiple fragments of printing material comprises the deposition of at least two zones of multiple fragments of printing material, wherein said at least two zones comprise different types of printing material. Such a way of depositing multiple fragments of printing material enables the manufacture of complex lens shapes and compositions, such as prisms and beam splitters.

The step of depositing of said at least two zones of multiple fragments of printing material can take place simultaneously.

In another embodiment the step of depositing of said at least two zones of multiple fragments of printing material takes place after one another.

In a preferred embodiment of the deposition of at least two zones of multiple fragments of printing material at least one zone comprises a light blocking material.

In yet another embodiment it is preferred that the lens structure(s) is/are interlocked with peripheral structures such as baffles, light blocking structures and conductive pads.

The mould as discussed above can be a wafer having well defined surface areas. The wafer is typically made of glass, and formed with an array or pattern of holes, which are formed by, for example, laser drilling of the wafer. The array of holes is aligned such that optical elements, e.g., lenses, can be formed in the substrate within the holes in the wafer.

Additional optical surfaces can be hot embossed on any free standing surface in any step of the present process, i.e. hot embossing for thermoplastic materials or an additional replicated structure on top of for actinic or thermo cured materials.

Various aspects of the present invention are illustrated by way of example, and not by way of limitation, in the accompanying drawings, wherein:

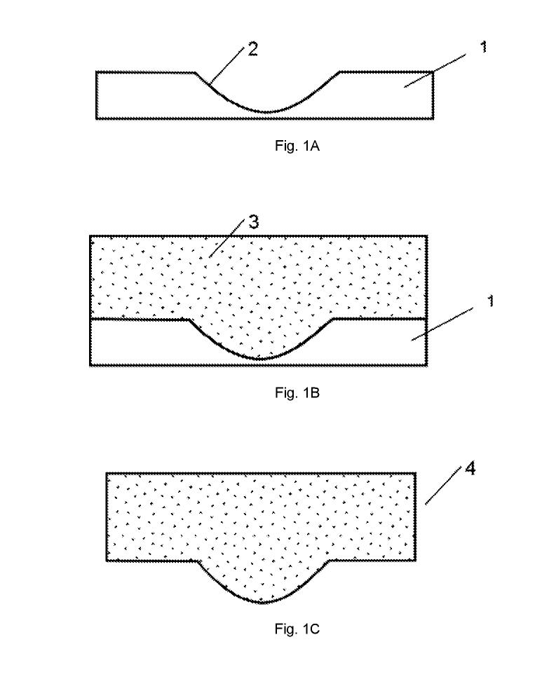

FIG. 1 shows an embodiment of the present method.

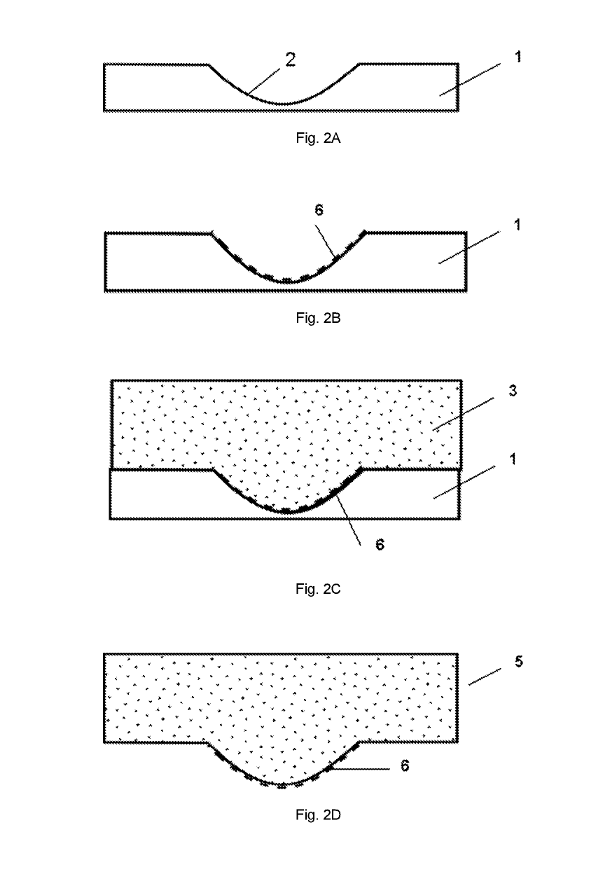

FIG. 2 shows another embodiment of the present method.

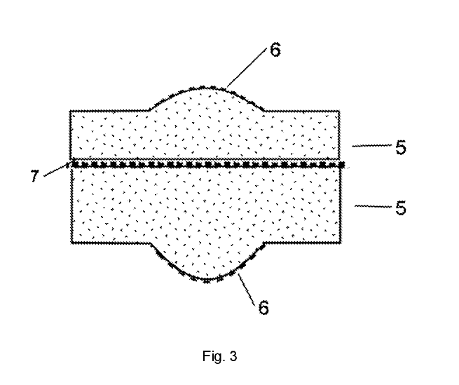

FIG. 3 shows another embodiment of the present method.

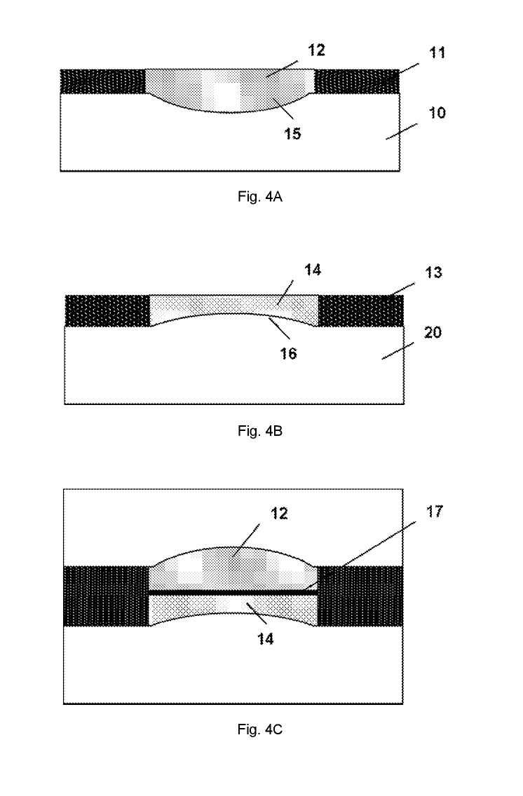

FIG. 4 shows another embodiment of the present method.

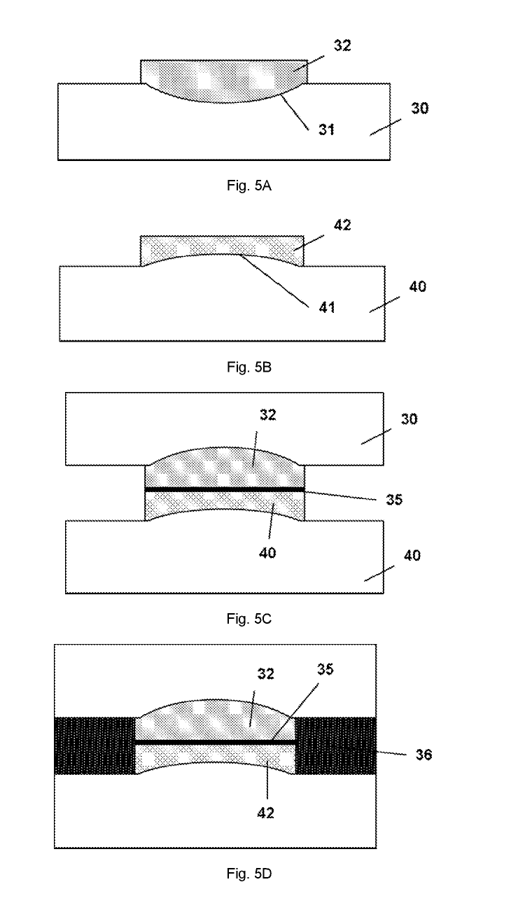

FIG. 5 shows another embodiment of the present method.

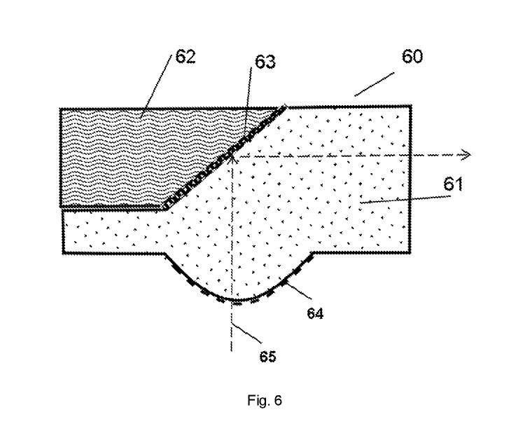

FIG. 6 shows another embodiment of the present method.

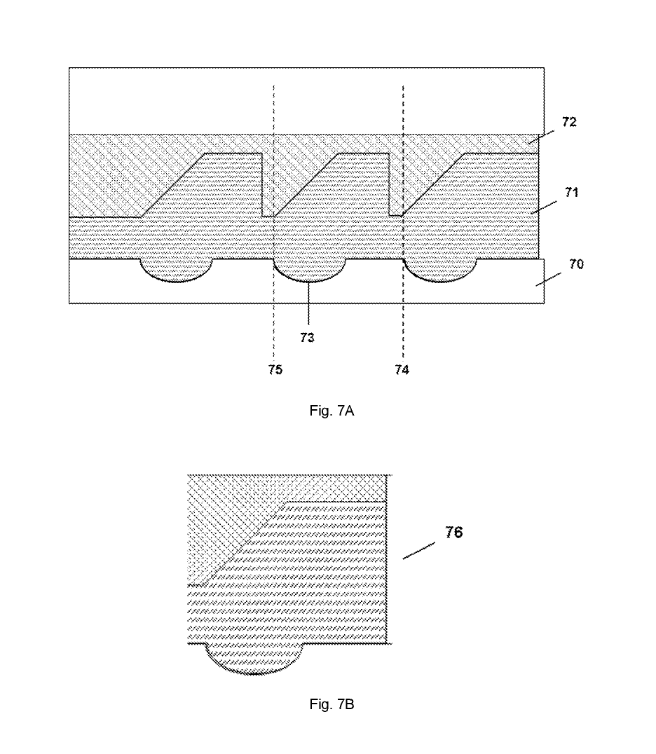

FIG. 7 shows another embodiment of the present method.

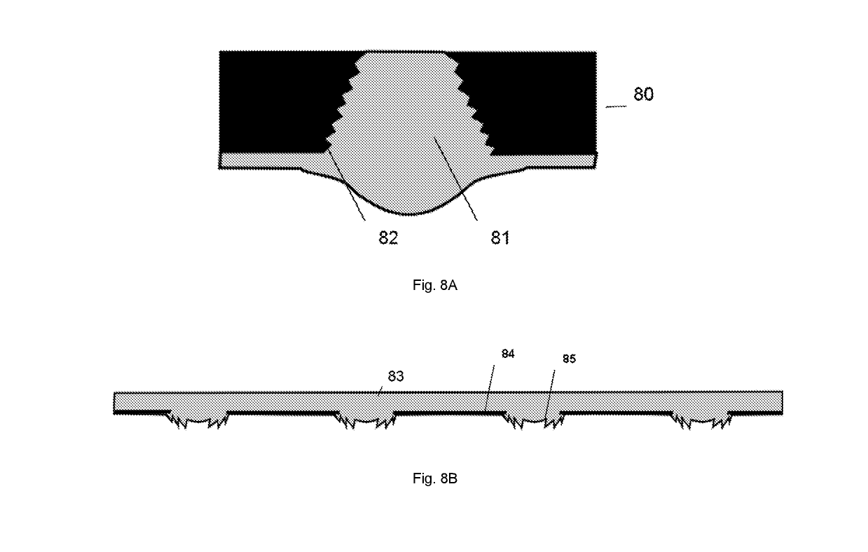

FIG. 8 shows another embodiment of the present method.

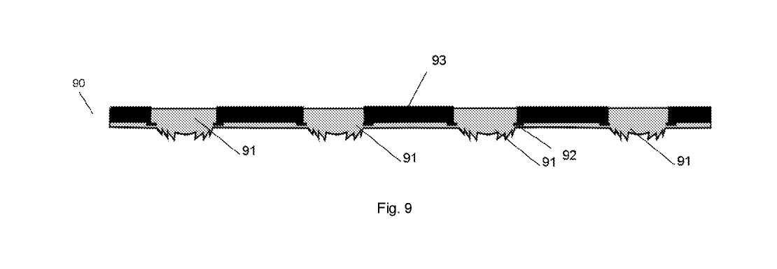

FIG. 9 shows another embodiment of the present method.

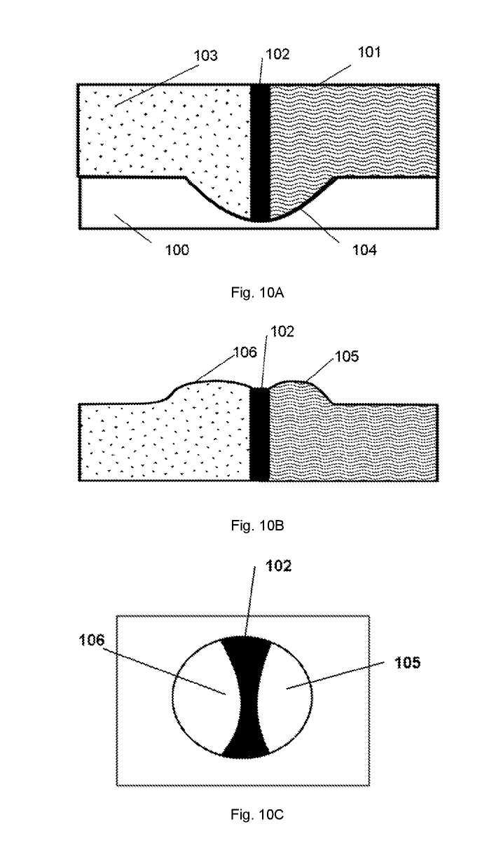

FIG. 10 shows another embodiment of the present method.

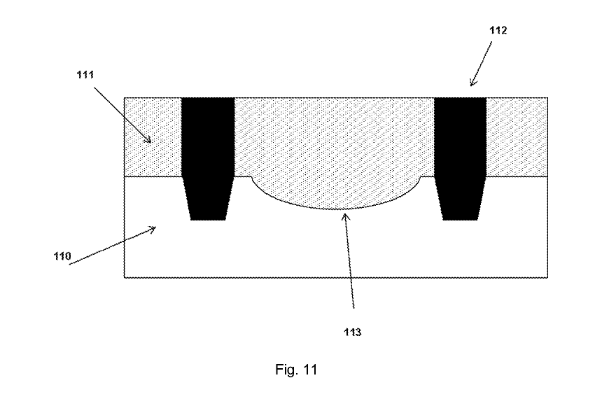

FIG. 11 shows another embodiment of the present method.

FIG. 1 shows in A the first step of the present method for printing a three-dimensional lens structure, i.e. the provision of a mould 1 having a well defined surface area 2. In step B multiple fragments of printing material 3 are deposited on the mould and cured to build up a three-dimensional lens structure 4 as shown in step C. The three-dimensional lens structure 4 shown here comprises a convex shape and, on the side opposite to the convex shape, a flattened side.

FIG. 2 shows in A the first step of the present method for printing a three-dimensional lens structure, i.e. the provision of a mould 1 having a well defined surface area 2. In step B an intermediary layer 6 of for example liquid UV curable or thermo setting polymer is applied to ensure a perfect match with the subsequent deposited fragments of the printing process. In step C multiple fragments of printing material 3 are deposited on intermediary layer 6 present in mould 1 and cured to build up a three-dimensional lens structure 5 as shown in step C. In step D three-dimensional lens structure 5 is shown, build up of cured resin material 3 wherein the concave part of three-dimensional lens structure 5 is provided with intermediary layer 6.

FIG. 3 shows a construction wherein two three-dimensional lens structure 5 are bonded together by means of a bonding medium 7 wherein an optical light path with at least two precise lens surfaces is obtained. Although three-dimensional lens structure 5 shows the presence of an intermediary layer 6, such a layer is optional. In the area between three-dimensional lens structure 5 one or more additional layers may be present, such as structured coatings, light blocking, filters, films, foils, diaphragm, aperture, additional glass substrates and flex prints. In more detail, the bonding medium layer 7 can be functionalized by the provision of one or more functional layers, such as structured (e.g. holes) coatings, light blocking, filters, black matrix, PEDOT & LCD films, foils, diaphragm, aperture, additional glass substrates, flex prints, for example FR4. Although FIG. 3 shows the bonding of two three-dimensional lens structure 5 having both a concave lens structure, other combinations of lens shapes are also possible, for example convex shape lens structures.

FIG. 4 shows in A a construction wherein the step of depositing multiple fragments of printing material comprises the deposition of at least two zones of multiple fragments of printing material. Mould 10 is provided with a well defined surface area 15 of the concave shape. Zone 11 and zone 12 are two zones comprising different types of printing material. In a preferred embodiment zone 11 consist of a light blocking material, whereas zone 12 consist of a transparent material, both materials have been deposited of fragments to build up said three-dimensional zones 11, 12. In B mould 10 is provided with a well defined surface area 16 of the convex shape. Zone 13 and zone 14 are two zones comprising different types of printing material. In a preferred embodiment zone 13 consist of a light blocking material, whereas zone 14 consist of a transparent material, both materials have been deposited of fragments to build up said three-dimensional zones 13, 14. In C the both three-dimensional zones 13, 14 and three-dimensional zones 11, 12 are bonded together by the use of a bonding agent 17. Materials in zones 11, 12, 13 and 14 may have different optical properties. Moulds 10, 20 can be removed after bonding three-dimensional zones 13, 14 and three-dimensional zones 11, 12. The composite construction consisting of three-dimensional lens structure 12, 14 surrounded by material 11, 13 can be used in an optical module. Layers 11, 13 can be used as a spacer. In the area between three-dimensional lens structure 12, 14 one or more additional layers may be present, such as structured coatings, light blocking, filters, films, foils, diaphragm, aperture, additional glass substrates and flex prints.

FIG. 5 shows in A the result of the present method for printing a three-dimensional lens structure, i.e. a mould 30 having a well defined surface area 31 of the concave shape provided with a segment of deposited multiple fragments of printing material as a three-dimensional lens structure 32. In FIG. 5B is shown a mould 40 having a well defined surface area 41 of the convex shape provided with a segment of deposited multiple fragments of printing material as a three-dimensional lens structure 42. In FIG. 5C both moulds 30, 40 and its three-dimensional lens structure 32, 42 are bonded together by the use of a bonding agent 35. The area located between the moulds 30, 40 can be filled with an additional curable resin 36 thereby obtaining a lens structure 32, 42 embedded in resin material 36. Such a cured resin material can have a light blocking function. Materials of zones 32, 35, 42 and may have different optical properties. Moulds 30, 40 can be removed after bonding together three-dimensional lens structure 32, 42 and filling the area located between moulds 30, 40. The composite construction consisting of three-dimensional lens structure 32, 42 surrounded by resin 36 can be used in an optical module. Resin material 36 can be used as a spacer. In the area between three-dimensional lens structure 32, 42 one or more additional layers may be present, such as structured coatings, light blocking, filters, films, foils, diaphragm, aperture, additional glass substrates and flex prints.

FIG. 6 shows a construction 60 manufactured according to the present method wherein a first segment 61 consists of fragments of printing material. First segment 61 has a sloped area 63 functioning as a reflective surface for light beam 65. Construction 60 further consists of a second segment 62 manufactured according to the present method, wherein the type of material for second segment 62 is different from the type of material for first segment 61. FIG. 6 is an embodiment of the deposition of at least two zones of multiple fragments of printing material, wherein the at least two zones comprise different types of printing material.

FIG. 7A shows an embodiment of a three-dimensional lens structure manufactured according to the present method. In mould 70 having a well defined surface area 73 multiple fragments of printing material 71 have been deposited and cured. The area 72 above the deposited and cured fragments has been provided with other multiple fragments of printing material 71 to build up the three-dimensional lens structure. FIG. 7A also shows dicing lines 74, 75 for singulating optical element 76, as shown in FIG. 7B.

FIG. 8A shows an optical element 80 consisting of a lens structure 81 and a baffle 82, both manufactured according to the present method wherein multiple fragments of different types of printing material have been deposited on a mould (not shown) and cured.

FIG. 8B shows an array with optical element 83 with an interlocked layer 84. Layer 84 may be printed according to the present method. Layer may also be an inserted patterned substrate. In the latter case the method of depositing multiple fragments of printing material is interrupted allowing the inserting the patterned substrate 84. A function of layer 84 is for example light blocking, filtering or electrical, thermal conductive. Layer 84 may also be structured in a pattern, e.g. a conductive circuit or a flex foil circuit.

FIG. 9 shows an optical element 90, wherein multiple fragments printing material 91 have been deposited on a Fresnel lens mould. However, the complete mould is not shown here. The multiple fragments printing material may be different for each lens. In addition each lens shape may be different as well. A diaphragm 92 is present around each lens and has been preferably manufactured according to the present method. The diaphragm may be circular, apodized. The segments between lenses 91 is made of a light blocking material, preferably manufactured according to the present method. In a preferred embodiment a frame or aperture hole substrate, for example FR4, may be inserted, for example when specific stiffness of the optical element is needed. Additional layers of deposited multiple fragments printing material may be applied on top of optical element 90.

FIG. 10A shows an optical element obtained by depositing multiple fragments of printing material 101, 103 on a mould 100 having a well defined surface area 104. The method further comprises the deposition of multiple fragments of printing material for forming 102, i.e. a light blocking element. The three zones of multiple fragments of printing material 101, 102, 103 may be printed at the same time, i.e. parallel, or one after the other.

FIG. 10B shows an optical element obtained by depositing multiple fragments of printing material and consisting of zones 102, 106, 105. The three zones of multiple fragments of printing material 102, 106, 105 may be printed at the same time, i.e. parallel, or one after the other.

FIG. 100 shows a top view of the optical element from FIG. 10B consisting of zones 102, 106, 105.

FIG. 11 shows a specific type of mould 110. Mould 110 comprises recesses 112 and a well defined surface area 113. After depositing multiple fragments of printing material on the mould 110 and curing the deposited fragments stand off elements 112 embedded in material 111 are obtained. Stand off elements 112 preferably have a light blocking function.

1. A method for printing a three-dimensional lens structure, comprising a step of depositing multiple fragments of printing material on a substrate and a step of curing the deposited fragments to build up said three-dimensional lens structure, wherein said substrate comprises a mould having a well defined surface area for obtaining said three-dimensional lens structure.

2. A method according to claim 1, further comprising forming an intermediate layer in said mould before said step of depositing multiple fragments of printing material on said mould.

3. A method for printing a three-dimensional lens structure according to claim 1, further comprising removing said mold from said three-dimensional lens structure after curing.

4. A method according to claim 1, further comprising bonding together two three-dimensional lens structures obtained according to the present method, wherein the contact surface between these two three-dimensional lens structures is formed by the surface remote from the mould having a well defined surface area.

5. A method according to claim 4, wherein the lens structures of the two three-dimensional lens structures differ from each other.

6. A method according to claim 4, wherein said step of bonding comprises the application of a bonding medium chosen from the group of adhesive and printing material used for printing said three-dimensional lens structures.

7. A method according to claim 4, wherein one or more layers are interposed between said two three-dimensional lens structures, wherein said one or more layers are chosen from the group of structured coatings, light blocking, filters, black matrix, PEDOT and LCD films, foils, diaphragm, aperture, additional glass substrates and flex prints.

8. A method according to claim 1, wherein said step of depositing multiple fragments of printing material comprises the deposition of at least two zones of multiple fragments of printing material, wherein said at least two zones comprise different types of printing material.

9. A method according to claim 8, wherein said step of depositing of said at least two zones of multiple fragments of printing material takes place simultaneously.

10. A method according to claim 8, wherein said step of depositing of said at least two zones of multiple fragments of printing material takes place after one another.

11. A method according to claim 8, wherein at least one zone comprises a light blocking material.

12. A method according to claim 1, wherein the lens structure(s) thus obtained is/are interlocked with peripheral structures.

13. A method according to claim 1, wherein said mould is a wafer having well defined surface areas.

14. A method according to claim 1, wherein said three dimensional lens structure is of the diffractive or refractive type.

15. A method according to claim 1, wherein said step of depositing multiple fragments of printing material on said substrate is carried out such that no inclusion of air bubbles in the thus deposited multiple fragments of printing material takes place.
